(19) United States
(12) Patent Application Publication
(10) Pub. No.: US 2026/0058192 A1
(43) Pub. Date: Feb. 26, 2026

(54) GLASS SOLID ELECTROLYTE AND LITHIUM ION BATTERY

(71) Applicant: IDEMITSU KOSAN CO.,LTD., Tokyo (JP)

(72) Inventors: Naoya MASUDA, Tokyo (JP); Kota TERAI, Tokyo (JP)

(73) Assignee: IDEMITSU KOSAN CO.,LTD., Tokyo (JP)

(21) Appl. No.: 18/996,109

(22) PCT Filed: Jul. 31, 2023
(86) PCT No.: PCT/JP2023/027918

§ 371 Date: Jan. 17, 2025

(30) Foreign Application Priority Data
Aug. 3, 2022 (JP) 2022-123800

(51) Int. Cl. H01M 10/0562; H01M 10/0525

(52) U.S. Cl. CPC H01M 10/0562; H01M 10/0525; H01M 2300/008

(57) ABSTRACT

A glass solid electrolyte comprising lithium, phosphorus, sulfur and halogen comprising at least bromine as constituent elements, wherein a molar ratio (Li/P) of the lithium (Li) to the phosphorus (P) is 2.0 to 5.3, a molar ratio (S/P) of the sulfur (S) to the phosphorus (P) is 2.0 to 4.5, and a molar ratio (X/P) of the halogen (X) to the phosphorus (P) is 0.7 to 2.3, and the glass solid electrolyte shows peaks derived from lithium bromide in powder X-ray diffraction using CuKα ray.

### TECHNICAL FIELD

The present disclosure relates to a glass solid electrolyte and a lithium-ion battery.

### BACKGROUND ART

In order to increase the performance of a lithium-ion battery, it is essential to increase the filling rate (consolidation characteristic) of a solid electrolyte powder. In order to increase the filling rate, it is effective to mechanically soften a solid electrolyte (to make it easier to deform by compression).

In lithium ion-conductive sulfide solid electrolytes, vitreous solid electrolytes are generally soft and therefore highly packed. Among them, Li₃PS₄ glasses are known to have a higher filing rate. Solid electrolyte including the Li₃PS₄ glass are disclosed in, for example. Patent Documents 1 to 3.

However, the Li₃PS₄ glass has an ionic conductivity as low as below 1 mS/cm.

### RELATED ART DOCUMENTS

### Patent Documents

[Patent Document 1] JP 5349427 B
[Patent Document 2] JP 5521899 B
[Patent Document 3] JP 5757284 B

### SUMMARY OF THE INVENTION

It is an object of the present disclosure to provide a glass solid electrolyte having a filling rate equal or higher than that of a conventional glass solid electrolyte, and a higher ionic conductivity.

According to the present disclosure, the following glass solid electrolyte and so on are provided.
1. A glass solid electrolyte comprises lithium, phosphorus, sulfur and halogen comprising at least bromine as constituent elements, wherein
   a molar ratio (Li/P) of the lithium (Li) to the phosphorus (P) is 2.0 to 5.3,
   a molar ratio (S/P) of the sulfur (S) to the phosphorus (P) is 2.0 to 4.5, and
   a molar ratio (X/P) of the halogen (X) to the phosphorus (P) is 0.7 to 2.3, and
   the glass solid electrolyte shows peaks derived from lithium bromide in powder X-ray diffraction using CuKα ray.
2. The glass solid electrolyte according to 1, wherein a crystallite size of lithium bromide calculated from the half-value width of a peak having the maximum intensity among the peaks derived from lithium bromide is 3 to 60 nm.
3. The glass solid electrolyte according to 1 or 2, wherein
   the halogen further comprises an iodine and
   the glass solid electrolyte shows peaks derived from a lithium iodide in X-ray powder diffraction using CuKα ray.
4. The glass solid electrolyte according to 3, wherein a crystallite size of lithium iodide calculated from the half-value width of the peak having the maximum intensity among the peaks derived from lithium iodide is 3 to 60 nm.
5. The glass solid electrolyte according to any one of 1 to 4, wherein a relative density of a green compact pressurized at 400 MPa is 90% or more.
6. The glass solid electrolyte according to any one of 1 to 5, having a true density of 2.0 to 3.0 g/cm³.
7. The glass solid electrolyte according to any one of 1 to 6, wherein the molar ratio (X/P) is greater than 0.75.
8. The glass solid electrolyte according to any one of 1 to 6, wherein the molar ratio (X/P) is greater than 0.86.
9. The glass solid electrolyte according to any one of 1 to 8, wherein
   the halogen further comprises an iodine,
   a molar ratio (I/P) of the iodine (I) to the phosphorus (P) is 2.0 or less, and
   a molar ratio (Br/P) of the bromine (Br) to the phosphorus (P) is 0.01 to 1.5.
10. The glass solid electrolyte according to any one of 1 to 9, having an ionic conductivity of 1 mS/cm or greater.
11. A lithium-ion battery comprising the glass solid electrolyte according to any one of 1 to 10.
12. A method for producing a glass solid electrolyte comprising steps of:
   combining two or more compounds containing lithium, phosphorus, sulfur, and a halogen (X) including at least bromine as constituent elements, or simple substances of the constituent elements, in a molar ratio (Li/P) of lithium (Li) to phosphorus (P) of 2.0 to 5.3, a molar ratio (S/P) of sulfur (S) to phosphorus (P) of 2.0 to 4.5, and a molar ratio (X/P) of halogen (X) to phosphorus (P) of 0.7 to 2.3, to form a mixture, and
   vitrifying the mixture.

According to the present disclosure, a glass sold electrolyte having a filling rate equal or higher than that of a conventional glass solid electrolyte, and a higher ionic conductivity can be provided.

### BRIEF DESCRIPTION OF THE DRAWINGS

FIG. 1 is a schematic diagram for explaining the pellet density measuring apparatus.

FIG. 2 is an X-ray diffraction pattern of the glass solid electrolytes prepared in Examples 1 to 4.

FIG. 3 is an X-ray diffraction pattern of the glass solid electrolytes prepared in Examples 5 to 8.

FIG. 4 is an X-ray diffraction pattern of the glass sold electrolytes prepared in Examples 9 to 13.

FIG. 5 is an X-ray diffraction pattern of the glass solid electrolytes prepared in Examples 14 and 15.

FIG. 6 is an X-ray diffraction pattern of the glass solid electrolytes prepared in Examples 16 to 18.

FIG. 7 is an X-ray diffraction pattern of the glass solid electrolyte prepared in Example 19.

FIG. 8 is an X-ray diffraction pattern of the glass solid electrolytes prepared in Comparative Examples 1 to 8.

FIG. 9 is an X-ray diffraction pattern of the glass solid electrolyte prepared in Comparative Examples 9 and 10.

### MODE FOR CARRYING OUT THE INVENTION

Hereinafter, the embodiment of the present disclosure will be described. In the present specification, numerical values of the upper limit and the lower limit of numerical values that are accompanied with “or more”, “or less”, and “to” can be arbitrarily combined. Numerical values described in Examples can also be used as those of the upper limit and the lower limit.

A glass solid electrolyte according to one aspect of the present disclosure contains lithium (Li), phosphorus (P), sulfur (S), and halogen (X) containing at least bromine as constituent elements. The molar ratios ((Li, S, or X)/P) of the constituent elements to phosphorus satisfies the following ranges:

$$Li / P = 2. to 5.3$$

$$S / P = 2. to 4.5$$

$$X / P = 0.7 to 2.3$$

In addition, the glass sold electrolyte shows peaks derived from lithium bromide in powder X-ray diffraction using CuKα ray.

A glass solid electrolyte of the present aspect has a higher content of halogen than a conventional glass solid electrolyte. As a result, the glass solid electrolyte of the present aspect has a filling rate as high as that of a conventional glass solid electrolyte and has a higher ionic conductivity can be obtained. For example, a glass solid electrolyte having a relative density of a green compact pressurized at 400 MPa (hereinafter referred to as a “400 MPa green compact”), which is an index of the filling rate, of 90% or more can be is obtained.

The glass solid electrolyte in the present disclosure means a solid electrolyte containing a glass (amorphous) component. Inclusion of the glass component can be confirmed by the presence of a broad peak (halo pattern) due to an amorphous component in X-ray diffractometry (XRD). In the XRD measurement of the glass solid electrolyte, a peak derived from a crystalline component or a peak derived from a raw material may be observed in part.

In one embodiment, the molar ratio (Li/P) of the lithium (Li) to the phosphorus (P) is preferably 3.0 to 5.25, more preferably 3.5 to 5.20, 3.8 to 5.0, and even more, may be 4.0 to 4.8.

In addition, the molar ratio (S/P) of the sulfur (S) to the phosphorus (P) is preferably 3.0 to 4.4, more preferably 3.5 to 4.3, and may be 3.8 to 4.2 or 3.9 to 4.1. By adjusting the molar ratio of the sulfur to the phosphorus in the above range, an effect of reducing the amount of hydrogen sulfide generated in a low dew point environment can be obtained.

The molar ratio (X/P) of the halogen (X) to the phosphorus (P) is preferably 0.75 to 2.5, more preferably 0.80 to 2.3, and may be 0.85 to 2.0, 0.90 to 1.8, or even 0.95 to 1.5.

The glass solid electrolyte of the present embodiment contains bromine and halogen other than bromine such as fluorine, chlorine, or iodine, as the constituent elements. The molar ratio (Br/X) of the bromine (Br) to the halogen (X) is preferably 0.05 to 1.0, more preferably 0.1 to 0.8.

The molar ratio (Br/P) of the bromine (Br) to the phosphorus (P) is preferably 0.05 to 2.0, more preferably 0.1 to 1.5, and may be 0.2 to 1.4, 0.3 to 1.3, or even 0.5 to 1.0.

In one embodiment, the halogen (X) contains bromine and iodine. The molar ratio (I/P) of the iodine (I) to the phosphorus (P) is preferably 2.0 or less, more preferably 0.1 to 1.5, and may be 0.2 to 1.4, 0.3 to 1.3, or even 0.5 to 1.0.

The type and molar ratio of the constituent elements of the glass solid electrolyte can be confirmed by, for example, an ICP emission spectrometer.

The molar ratios of the constituent elements of the glass solid electrolyte can be adjusted by varying blending amounts of raw materials. The molar ratios of the constituent elements in the raw material are substantially equal to the molar ratio of the constituent elements of the obtained glass solid electrolyte.

In the glass solid electrolyte of the present embodiment, it is preferable that the molar ratio (Li/P) and the molar ratio (X/P) satisfy the following formula (1):

$$Li / P = ( 3 \pm α ) + X / P \qquad ( 1 )$$

(In the formula, α is 0 to 0.5.)

When the formula (1) is satisfied, since the generation amount of PS₄³⁻ tetrahedral structure, which is the main skeleton of the glass solid electrolyte, increases, the effect of reducing the amount of hydrogen sulfide generated in a low dew point environment can be obtained. In addition, since the generation amount of P₂S₆⁴⁻ structure and P₂S₇⁴⁻ structure that are larger and stiffer than PS₄³⁻ structure decreases, an effect of increasing the softness of the glass solid electrolyte can be obtained.

The α of the formula (1) may be 0 to 0.3, 0 to 0.1, or 0.

In one embodiment, the glass solid electrolyte preferably has a true density of 2.0 to 3.0 g/cm³. When the true density is within the above range, it means that the Li₃PS₄ glass contains a certain amount of halogen, and the contained halogen imparts softness to the solid electrolyte and increases the ionic conductivity higher than that of the Li₃PS₄ glass.

The true density of the glass solid electrolyte is more preferably 2.05 to 2.9 g/cm³, and particularly preferably 2.1 to 2.8 g/cm³.

The true density of the glass solid electrolyte can be measured, for example, by a gas-phase displacement method using He gas. A method of measuring a true density of the glass solid electrolyte is described in detail in Examples.

In one embodiment, the glass solid electrolyte has diffraction peaks of lithium halide, such as lithium iodide, in addition to those of lithium bromide, in powder X-ray diffractometry using CuKα ray. Lithium halide observed by powder X-ray diffractometry of the glass sold electrolyte has a crystallinity lower than that of lithium halide of the raw material. By the glass sold electrolyte having diffraction peaks of lithium halide, additional mechanical softness can be added to the glass solid electrolyte itself.

Among the peaks derived from lithium halide, a peak having the maximum intensity is observed, for example, in a position within a range in which 2θ is 25 to 30° (deg).

In one embodiment, the lithium halide is a lithium iodide.

In one embodiment, the crystallite size calculated from the peak half-value width of the peak having the maximum intensity among the peaks derived from lithium bromide is 3 to 60 nm. It is preferably 5 to 50 nm, and more preferably 7 to 40 nm.

In general, the diffraction peak of powder X-ray diffraction measurement has a width, and a peak width at a half height of the peak height obtained by subtracting the background therefrom is referred to as the half-value width. It is known that there is a correlation between the half-value width and the crystallite size. When the crystallite size is large, the crystallinity becomes high, and since the repeating regularity of the crystalline structure becomes high, the half-value width of the diffraction peak of the powder X-ray diffraction measurement becomes narrowed.

The crystallite size can be adjusted by the composition. For example, the crystallite size can be adjusted by varying the molar ratio (Li/P) of the lithium (Li) to the phosphorus (P), the molar ratio (Br/X) of the bromine (Br) to the halogen (X), and the molar ratio (I/P) of the iodine (I) to the phosphorus (P).

When a solid electrolyte is glass-state, the half-value width becomes extremely large and the diffracted peak becomes broader.

In addition, in one embodiment, when peaks derived from lithium iodide are present, the crystallite size calculated from the peak half-value width of the peak having the maximum intensity among the peaks is 3 to 60 nm. It is preferably 5 to 50 nm, and more preferably 7 to 40 nm.

The peak half-value width and the crystallite size are calculated from XRD. The details of the measurement and the calculation method are given in Examples. It should be noted that whether or not a crystallite is present, that is, whether or not peaks of LiBr and LiI are observed is also determined by the above calculation method.

The calculation target of the peak half-value width is, for example, a diffraction peak of 2θ=28±1° in the case of LiBr, and a diffraction peak of 2θ=25.5±1° in the case of LiI.

The glass solid electrolyte of the present embodiment has a filling rate equal or higher than that of a conventional glass solid electrolyte, and a higher ionic conductivity.

Specifically, a relative density of the 400 MPa green compact, which is an index of the filling rate, can be 90% or higher. The relative density may be 90.5% or higher, or may be 91% or higher. The upper limit of the relative density is not particularly limited, but is usually 99% or lower.

In the present disclosure, the relative density of a 400 MPa green compact means a ratio of the density of pellets obtained by application of 400 MPa to compress the glass solid electrolyte powder (referred to as pellet density), with respect to the true density of the glass electrolyte powder (relative density (%)=pellet density×100/true density). The higher relative density means a higher filling rate.

The details of the measurement method of the relative density of a 400 MPa green compact are described in Examples.

In addition, the ionic conductivity of the glass solid electrolyte of the present embodiment can be 1 mS/cm or greater, and also can be 1.1 mS/cm or greater.

The glass solid electrolyte of the present embodiment can be produced, for example, by mixing starting raw materials of a known lithium ionic sulfide solid electrolyte such that a molar ratio of constituent elements satisfies the predetermined range to obtain a mixture, and by vitrifying the mixture.

As the starting raw materials, two or more compounds containing lithium, phosphorus, sulfur, and a halogen (X) including at least bromine as constituent elements, or simple substances of the constituent elements can be used in combination, and any material capable of exhibiting ionic conductivity caused by the contained metal atoms can be employed without any particular limitation.

Examples of raw materials containing lithium (Li) include lithium compounds such as lithium sulfide (Li₂S), lithium oxide (Li₂O), lithium carbonate (Li₂CO₃), and lithium simple metal substance. Among them, lithium compounds are preferable, and lithium sulfide is more preferable.

The above-described lithium sulfide can be used without any particular limitation, but a lithium sulfide having a high purity is preferable. Lithium sulfide can be produced, for example, by the method described in JP-H07-330312 A, JP-H09-283156 A, JP 2010-163356 A, and JP 2011-84438 A.

Specifically, lithium hydroxide and hydrogen sulfide are reacted in a hydrocarbon-based organic solvent at 70° C. to 300° C. to form lithium hydrosulfide, and then, hydrogen sulfide is removed from this reaction solution to form lithium sulfide (JP 2010-163356 A).

Further, by reacting lithium hydroxide and hydrogen sulfide in an aqueous solvent at 10° C. to 100° C. to form lithium hydrosulfide, and then hydrogen sulfide is removed from this reaction liquid to form lithium sulfide (JP 2011-84438A).

Examples of raw materials containing phosphorus (P) include phosphorus sulfides such as diphosphorus trisulfide (P₂S₃), and diphosphorus pentasulfide (P₂S₅); phosphorus compounds such as sodium phosphate (Na₃PO₄); and phosphorus simple compound. Of these, phosphorus sulfides are preferred, and diphosphorus pentasulfide (P₂S₅) is more preferred. Phosphorus compounds such as diphosphorus pentasulfide (P₂S₅) and phosphorus simple compound can be used without any particular limitation as long as they are industrially manufactured and sold.

The raw material containing halogen (X) as a constituent element preferably contains halogen compounds represented by, for example, the following formula.

Mₗ-Xₘ

In the formula, M represents an element such as sodium (Na), lithium (Li), boron (B), aluminum (Al), silicon (Si), phosphorus (P), sulfur (S), germanium (Ge), arsenic (As), selenium (Se), tin (Sn), antimony (Sb), tellurium (Te), lead (Pb), or bismuth (Bi); or a group formed by bonding an oxygen element or sulfur element to these elements. Lithium (Li) or phosphorus (P) is preferred, and lithium (Li) is more preferred.

X is a halogen element selected from fluorine (F), chlorine (Cl), bromine (Br), and iodine (I).

In addition, I is an integer of 1 or 2, and m is an integer of 1 to 10. When m is an integer of 2 to 10, that is, when a plurality of Xs are present, Xs may be the same or different. For example, in SiBrCl₃ described later, m is 4, and Xs are composed of different elements of Br and Cl.

Specific examples of the halogen compound include sodium halides such as NaI, NaF, NaCl, and NaBr; lithium halides such as LiF, LiCl, LiBr, and LiI; boron halides such as BCl₃, BBr₃, and BI₃; aluminum halides such as AlF₃, AlBr₃, AlI₃, and AlCl₃; silicon halides such as SiF₄, SiCl₄, SiCl₃, Si₂Cl₆, SiBr₄, SiBrCl₃, SiBr₂Cl₂, and SiI₄; phosphorus halides such as PF₃, PF₅, PCl₃, PCl₅, POCl₃, PBr₃, POBr₃, PI₃, P₂Cl₄, and P₂I₄; sulfur halides such as SF₂, SF₄, SF₆, S₂F₁₀, SCl₂, S₂Cl₂, and S₂Br₂; germanium halides such as GeF₄, GeCl₄, GeBr₄, GeI₄, GeF₂, GeCl₂, GeBr₂, and GeI₂; arsenic halides such as AsF₃, AsCl₃, AsBr₃, AsI₃, and AsF₅; selenium halides such as SeF₄, SeF₆, SeCl₂, SeCl₄, Se₂Br₂, and SeBr₄; tin halides such as SnF₄, SnCl₄, SnBr₄, SnI₄, SnF₂, SnCl₂, SnBr₂, and SnI₂; antimony halides such as SbF₃, SbCl₃, SbBr₃, SbI₃, SbF₅, and SbCl₅; tellurium halides such as TeF₄, Te₂F₁₀, TeF₆, TeCl₂, TeCl₄, TeBr₂, TeBr₄, and TeI₄; lead halides such as PbF₄, PbCl₄, PbF₂, PbCl₂, PbBr₂, and PbI₂; and bismuth halides such as BiF₃, BiCl₃, BiBr₃, and BiI₃.

Among them, preferred examples thereof include lithium halides such as lithium chloride (LiCl), lithium bromide (LiBr), and lithium iodide (LiI); and phosphorus halides such as phosphorus pentachloride (PCl₅), phosphorus trichloride (PCl₃), phosphorus pentabromide (PBr₅), and phosphorus tribromide (PBr₃). Among these, lithium halides such as LiCl, LiBr, and LiI; and PBr₃ are preferable, and lithium halides such as LiCl, LiBr, and LiI are more preferable, and LiI and LiBr are more preferable.

As the halogen compound, the compound described above may be used alone or in combination of two or more kinds. That is, at least one of the above compounds may be used.

In the present embodiment, the raw materials preferably contain a lithium compound, a phosphorus compound and a halogen compound containing at least bromine, and at least one of the lithium compound and phosphorus compound contain sulfur element, more preferably in combination of lithium sulfide, phosphorus sulfide and two or more lithium halides, and still more preferably in combination of lithium sulfide, diphosphorus pentasulfide and two or more kinds of lithium halides.

For example, when lithium sulfide, diphosphorus pentasulfide and two or more kinds of lithium halides are used as the raw materials of a glass solid electrolyte, the molar ratio of lithium sulfide to diphosphorus pentasulfide in the charged raw materials is preferably 65 to 85:15 to 35, more preferably 70 to 80:20 to 30, still more preferably 72 to 78:22 to 28, and particularly preferably 75:25.

When the amount of substance of Li₃PS₄ calculated from the constituent elements Li, P and S of lithium sulfide and diphosphorus pentasulfide is set to 100 parts by mole, the amount of lithium halide is preferably 75 to 250 parts by mole, more preferably 80 to 225 parts by mole, and may be 85 to 200 parts by mole, 90 to 175 parts by mole, or 95 to 150 parts by mole.

In the present embodiment, the raw material is reacted by applying mechanical stress to form a glass solid electrolyte. Herein, “applying mechanical stress” is mechanical application of shear stress, impact force, or the like. Means for application of mechanical stress includes, for example, use of pulverizers such as a planetary ball mill, a vibration mill, or a rolling mill; and a kneader. The raw materials are ground and mixed with strong mechanical stress, until at least a part thereof cannot maintain the crystallinity.

As the conditions of grinding and mixing, for example, when using a planetary ball mill as a pulverizer, treatment may be carried out at a rotational speed of several tens to several hundreds revolutions per minute for 0.5 hours to 100 hours. More specifically, in the case of using the planetary ball mill (manufactured by Fritsch: Model No. P-5) used in Examples, treatment may be carried out at a rotational speed of preferably 100 rpm or more and 400 rpm or less, and more preferably 150 rpm or more and 300 rpm or less. The temperature at the time of grinding may be room temperature, and in this case, cooing from the outside may not be performed, for example, an operation pause period of 5 minutes every hour may be taken. Note that, if the conditions are such that crystallization does not occur during pulverization, it may be performed while cooling without taking an operation pause period.

When, for example, balls made of zirconia are used as the pulverization media, its diameter is preferably 0.2 to 20 mm.

The glass solid electrolyte of the present embodiment is preferably used in a battery because it has a filling rate higher than a conventional glass solid electrolyte, and a higher ionic conductivity. It is particularly suitable when lithium element is used as the conductive species. The glass solid electrolyte of the present embodiment may be used for a positive electrode layer, a negative electrode layer, or an electrolyte layer.

A lithium-ion battery according to one aspect of the present disclosure contains the glass solid electrolyte of the present disclosure described above. For example, an all-solid lithium-ion battery can be produced by using the glass solid electrolyte of the present disclosure instead of a liquid-based electrolyte.

An all-solid lithium-ion battery is mainly composed of a positive electrode layer, a negative electrode layer, and an electrolyte layer, but the glass solid electrolyte of the present disclosure can be used in any of these layers. Note that each layer can be produced by a known method.

For example, when the glass solid electrolyte of the present disclosure is used in a positive electrode layer and a negative electrode layer, a positive electrode active material or a negative electrode active material is mixed and dispersed therein to obtain a positive electrode mixture or a negative electrode mixture.

The positive electrode active material is not particularly limited as long as the positive electrode active material can accelerate a cell chemical reaction accompanied by the migration of lithium ions caused by lithium element, which is preferably employed as an element for expressing ion conductivity in the present embodiment, in relation to the negative electrode active material. Examples of the positive electrode active material capable of intercalating and deintercalating lithium ions include an oxide-based positive electrode active material and a sulfide-based positive electrode active material.

Preferred examples of the oxide-based positive electrode active material include LMO (lithium manganese), LCO (lithium cobaltate), NMC (lithium nickel manganese cobalt oxide), NCA (lithium nickel cobalt aluminate), LNCO (lithium nickel cobalt oxide), and transition metal complex oxides containing lithium such as olivine-type compounds (LiMeNPO₄, Me=Fe, Co, Ni, Mn).

Examples of the sulfide-based positive electrode active material include titanium sulfide (TiS₂), molybdenum sulfide (MoS₂), iron sulfide (FeS, FeS₂), copper sulfide (CuS), nickel sulfide (Ni₃S₂), and the like.

In addition to the above-mentioned positive electrode active material, niobium selenide (NbSe₃) or the like can also be used.

In the present embodiment, the positive electrode active material may be used alone or in combination of a plurality of types.

As the negative electrode active material, substances can be used without any particular limitation as long as it can accelerate a battery chemical reaction accompanied by the migration of lithium ions, preferably caused by a lithium element, such as an element preferably employed as an element for expressing ionic conductivity in the present embodiment, preferably a metal capable of forming an alloy with a lithium element, an oxide thereof, and an alloy of the metal and a lithium element. As such negative electrode active materials capable of intercalating and deintercalating lithium ions, known materials in the field of a battery as a negative electrode active material can be employed without limitation.

Examples of such negative electrode active materials include metal simple substances such as metal lithium, metal indium, metal aluminum, metal silicon, and metal tin; metals capable of forming an alloy with metal lithium; oxides of these metals; and alloys of these metals with metal lithium.

The electrode active material used in the present embodiment may be ones having a coating layer on which its surface is coated.

Examples of material for forming the coating layer preferably include an ionic conductor such as a nitride, an oxide, or a complex thereof of an element, preferably a lithium element, which exhibits an ionic conductivity in the crystallinity sulfide solid electrolyte used in the present embodiment. Specifically, examples thereof include a conductor having a LISICON type crystalline structure such as Li₄₋₂ₓZnₓGeO₄ having lithium nitride (Li₃N) or Li₄GeO₄ as a main structure, a conductor having a thio-LISICON type crystalline structure such as Li₄₋ₓGe₁₋ₓPₓS₄ having a Li₃PO₄ type skeleton structure, a conductor having a perovskite type crystalline structure such as La_{2/3-x}Li₃ₓTiO₃, and a conductor having a NASICON type crystalline structure such as LiTi₂(PO₄)₃.

In addition, examples thereof include lithium titanate such as Li_{y}Ti_{3-y}O₄ (0<y<3) and Li₄Ti₅O₁₂ (LTO), lithium metalates composed of a metal belonging to Group 5 of the periodic table, such as LiNbO₃ and LiTaO₃, and oxide-based conductors such as Li₂O—B₂O₃—P₂O₅ type, Li₂O—B₂O₃—ZnO type, and Li₂O—Al₂O₃—SiO₂—P₂O₅—TiO₂ type.

The electrode active material having a coating layer is obtained, for example, by adhering a solution containing various elements constituting the material forming the coating layer on the surface of the electrode active material, and by firing the electrode active material after the adhesion at preferably 200° C. or higher and 400° C. or lower.

Here, as the solution containing various elements, for example, a solution containing a metal alkoxide of various metals such as lithium ethoxide, titanium isopropoxide, niobium isopropoxide, and tantalum isopropoxide may be used. In the case of using the solution of a metal alkoxide, as the solvent, an alcohol-based solvent such as ethanol or butanol, an aliphatic hydrocarbon solvent such as hexane, heptane, or octane; an aromatic hydrocarbon solvent such as benzene, toluene, or xylene may be used.

The above-described adhesion may also be performed by immersion in the solution, spray coating with the solution, or the like.

The firing temperature is preferably 200° C. or higher and 400° C. or lower, and more preferably 250° C. or higher and 390° C. or lower, and the firing time is usually about 1 minute to 10 hours, and preferably 10 minutes to 4 hours, from the viewpoint of increasing the production efficiency and the battery performance.

The coverage rate of the coating layer is preferably 90% or more, more preferably 95% or more, and still more preferably 100%, that is, the entire surface is coated, on the basis of the surface area of the electrode active material. The thickness of the coating layer is preferably 1 nm or more, and more preferably 2 nm or more, and the upper limit is preferably 30 nm or less, and more preferably 25 nm or less.

The thickness of the coating layer can be measured by cross-sectional observation using the transmission electrons microscopy (TEM), and the coverage rate can be calculated from the thickness of the coating layer, elemental analysis value, and BET surface area.

The above-mentioned battery preferably uses a current collector in addition to the positive electrode layer, the electrolyte layer, and the negative electrode layer. As the current collector, known current collectors can be used. As examples of the current collectors, a layer of a material that reacts with the above-mentioned glass solid electrolyte, such as Au, Pt, Al, Ti or Cu, coated with Au or the like can be used.

### Examples

The present disclosure is specifically described by reference to Examples. The embodiments of the present disclosure are not limited to Examples. The methods for evaluating the glass solid electrolyte prepared in the respective Examples are as follows:

### (1) Powder X-Ray Diffraction (XRD) Measurement

The glass solid electrolyte powders prepared in the respective Examples were filled into a groove with a diameter of 20 mm and a depth of 0.2 mm, and the excess powder was scraped off with a glass. The filled samples were measured without being exposed to the atmosphere by the use of a Kapton film for XRD. The 2θ position of a diffraction peak was determined by Le Bail analysis using an XRD analysis program RIETAN-FP.

The powder X-ray diffraction measurement was performed under the following conditions.
Equipment used: “D2 PHASER” manufactured by BRUKER
Tube voltage: 30 kV
Tube current: 10 mA
X-ray wavelength: Cu-Kα ray (1.5418 Å)
Optical system: Convergence method
Slit configuration: Solar sit 4°, Divergence slit 1 mm, Kβ filter (Ni plate) is used
Detector: Semiconductor detector
Measuring range: 2θ=10 to 60° (deg)
Step-width, Scanning speed: 0.05°, 0.05°/sec

In the analysis of a peak position to ascertain the presence of a crystalline structure on the basis of a measurement result, the XRD analytic program RIETAN-FP was used, a base line was corrected by 11th-degree Legendre orthogonal polynomials, and a peak position was found.

### (2) Peak Half-Value Width

Peak half-value widths were calculated at a peak of 2θ=25.5±1° in the case of LiI and at a peak of 2θ=28±1° in the case of LiBr.

The half-value width parameter E was determined in such a way that the difference between the measured values of the intensities (vertical axis values of XRD patterns) and the calculated values below was minimized in the range (2θ=24.5 to 26.5° or 2θ=27 to 29°) where the above-mentioned peaks were present.

The proportion of the Lorentz function is A (0≤A≤1), the intensity correction value is B, the angle of 2θ where the intensity is maximum is C, the angle of the intensity to be calculated (2θ) is D, the half-value width parameter is E, the background is F, and the measured value of the intensity at the angle of the intensity to be calculated (2θ) is G. A, B, C, E, and F are variables, and the gap H between the measured value of the intensity and the calculated value is calculated by the following formula (3) for each angle (2θ) at which the intensity is measured.

$$H = G - \{ B \times \{ A / ( 1 + {( D - C )}^{2} / {E}^{2} ) + ( 1 - A ) \times exp ( - 1 \times {( D - C )}^{2} / {E}^{2} ) \} + F \} \qquad ( 3 )$$

The above variables were determined by summing H's in the range of 2θ=24.5 to 26.5° or 2θ=27 to 29°, and minimizing the sum of H's in a GRG non-linear manner using the solver function of spreadsheet software (Excel. Microsoft).

Using the determined half-value width parameter E, the half-value width was calculated with the following formula (4):

$$Half - Value Width = E \times 2 \times {( ln 4 )}^{( 1 / 2 )} \qquad ( 4 )$$

If the peak intensity is calculated to be zero, the half-value width parameter cannot be calculated, so that there is no peak at this case, that is, no peak derived from LiI or LiBr and no crystallites can be considered to be present.

### (3) Crystallite Size

The half-value width calculated by the above method was set to b. In order to compensate the spread of the half-value width due to the device used, the half-value width was corrected with NIST standard Si (640d, crystallite size: 525 nm). When the half-value width due to the device as corrected is taken as a B_{correct}, the corrected half-value width β for calculating the crystallite size can be expressed by the following formula (5).

$$β = b - {B}_{correct} \qquad ( 5 )$$

The actual crystallite size L can be calculated by the following formula (6):

$$L = K \times λ / ( β cos ( C / 2 ) ) \qquad ( 6 )$$

Wherein the constant K is 0.9, and λ is the wavelength of the X-ray used for the measurement. Note that, C is the 2θ of the central position of the maximum peak used in the calculation of the peak half-width above.

### (4) Relative Density of 400 MPa Green Compact

### (Measurement of True Density)

The true density was measured by a gas phase displacement method using He gas (BELMAX, manufactured by Microtracbell). The internal volumes of the cell were calculated at the He gases pressure of 55 KPa, 60 KPa, 65 KPa, 70 KPa, 75 KPa, 80 KPa, 85 KPa, 90 KPa, 95 KPa, 100 KPa, 105 KPa and 110 KPa, respectively, and the average of these calculated volumes was taken as the cell internal volume. The cell weight was also calculated using an electronic balance. The capacity and weight of the blank cell were taken three times by the above-described method, the average value was set as the empty cell capacity V₁, and the weight was set as the empty cell weight W₁. The capacity of the gas phase portion in the cell and the total weight of the cell, when the glass solid electrolyte was charged in the cell were taken three times by the above-described method, and the average values thereof were taken as the volume V₂ excluding the sample, and as the total weight of the cell as W₂, respectively.

The true density d (g/cm³) of the glass solid electrolyte was calculated by the following formula (7):

$$d = ( {W}_{2} - {W}_{1} ) / ( {V}_{1} - {V}_{2} ) \qquad ( 7 )$$

The true density of the sample was defined as the average value of the true densities d calculated three times by the above formula. The standard deviation of the true density calculated by this method is 0.05 g/cm³ or less.

### (Measurement of Pellet Density)

A schematic diagram of a pellet density measuring device is shown in FIG. 1.

The sample 10 was charged in a cylindrical jig 11 (manufactured by Makor (registered trademark)) and pressurized at a pressure of 400 MPa by a single-spindle pressing machine via a stainless-steel piston 12. The height of the sample (pellet) was measured from the difference between the length Lᵢₙₜ of the device in which the sample was not charged (blank) and the length Latter of the device charged with the sample after pressurizing, and the pellet density dₚₑₗₗₑₜ was calculated therefrom.

Specifically, the piston 12 was inserted into the cylindrical jig 11 having a diameter of 10 mm (cross-sectional area Sₚₑₗₗₑₜ: 0.785 cm²) prior to input of a sample. The cylindrical jig 11 was rotated every 90° in a direction perpendicular to the pressing direction, the length of the device in which the sample was not charged (blank) was measured four times, and the average value thereof was defined as Lᵢₙₜ (cm). At this time, while applying pressure to the piston 12 by tightening the screw 13 and the nut 14 with a pressure of 8 N·m using a torque wrench, the length of the device in which the sample was not charged (blank) was measured.

Next, 0.3 g of the glass solid electrolyte powder as a sample was weighed by an electronic balance and charged into the cylindrical jig 11. After charging, the sample was pressure-molded by pressurizing the piston 12 with a single-spindle pressing machine. The pressure was maintained at 185 MPa for 2 minutes and then depressurized. The cell was rotated at 120° in the vertical direction from the pressing direction and pressed in the same manner. Then, it was rotated again 120° and pressed in the same manner. Next, the sample was pressurized at 400 MPa in the same manner as at a pressure of 185 MPa, using.

After molding, the length of the device charged with the sample after pressurizing was measured four times in the same manner as in Lᵢₙₜ, and the average value thereof was defined as L_{after} (cm). The pellet density dₚₑₗₗₑₜ was calculated by the following formula (8).

$${d}_{pellet} = 0.3 / \{ ( {L}_{after} - {L}_{int} ) \times {S}_{pellet} \} \qquad ( 8 )$$

### (Calculation of Relative Density)

$$The relative density was calculated by the following formula ( 9 ) :$$

$$Relative density ( \% ) = pellet density \times 100 / true density \qquad ( 9 )$$

### (5) Ionic Conductivity

A circular pellet having a diameter of 10 mm (cross-sectional area S: 0.785 cm²) and a height (L) of 0.1 to 0.3 cm was formed of the glass solid electrolyte prepared in respective Examples, and used it as a sample. The current collectors were attached to the top and bottom of the sample, and Impedance spectra were measured at 25° C. (frequency range: 5 MHz to 0.5 Hz, amplitude: 10 mV) to obtain Cole-Cole plots. In the vicinity of the right end of the arc observed in the high-frequency region, the real part Z′ (Ω) at the point where −Z″ (Ω) is the smallest was taken as the bulk-resistance R (Ω) of the electrolyte, and the ionic conductivity σ (S/cm) was calculated by the following formula:

$$R = ρ ( L / S )$$

$$σ = 1 / ρ$$

### (6) Measurement of ICP

The solid electrolyte powders prepared in respective Examples were weighed and collected in a vial in an argon atmosphere. A KOH alkaline aqueous solution was placed in the vial, and the samples were appropriately diluted and dissolved while being careful not to collect sulfur content. The dissolved solutions were used as measurement solutions. This solution was subjected to measurement using a Paschen Runge type ICP-OES (SPECTRO ARCOS manufactured by SPECTRO), and the composition was determined.

Calibration solutions for Li, P and S were prepared by using a 1000 mg/L standard solution for ICP measurement, respectively. Calibration solutions for Cl and Br were prepared by using a 1000 mg/L standard solution for ion chromatography, respectively.

Two measurement solutions were prepared for each sample, measurement was performed five times for each measurement solution, and the average value was calculated. The composition was determined by averaging the measured values of the two measurement solutions.

### Example 1

### [Preparation of Glass Solid Electrolyte]

### (1) Preparation of Glass Solid Electrolyte

Raw materials were weighed to be such that 2.366 g of lithium sulfide, 3.815 g of diphosphorus pentasulfide, 3.446 g of lithium iodide, and 0.373 g of lithium bromide were weighed, and 600 g of zirconia balls having a diameter of 10 mm were put into a 500 mL of zirconia pot together with the raw materials, and the pot was sealed. Table 1 shows the molar ratios of the starting raw materials.

Using a planetary ball mill (model number P-5, manufactured by Fritsch), the glass sold electrolyte was obtained by grinding treatment (mechanical milling) at room temperature at a rotational speed of 220 rpm for 40 hours.

Table 1 shows the raw material composition ratio, the molar ratio of each element to phosphorus (P), and evaluation results.

### Examples 2 to 19 and Comparative Examples 1 to 10

Glass solid electrolytes were prepared in the same manner as in Example 1, except that the raw material composition ratio was changed as shown in Table 1. The evaluation results are shown in Table 1.

In Table 1, the amount of substance of Li₃PS₄ was 100 parts by mole, and this corresponds to 150 parts by mole of Li₂S₄ and 50 parts by mole of P₂S₅ as the starting raw materials.

For Examples 7, 14, 16, and Comparative Examples 1 and 7, the molar ratios (X/P) of the respective elements to phosphorus (P) of the glass solid electrolyte were measured by ICP. The results are listed below.
Example 7: Li/P=4.4, S/P=3.9, Br/P=0.25, I/P=1.26
Embodiment 14: Li/P=3.9, S/P=3.9, Br/P=0.53, I/P=0.52
Embodiment 16: Li/P=4.0. S/P=4.0, Br/P=1.05
Comparative Example 1: Li/P=3.0, S/P=4.0
Comparative Example 7: Li/P=4.4, S/P=4.0, I/P=1.52

TABLE 1

| | Molar Ratio of | | | Molar Ratio Relative | | | | | Crystallite | Crystallite | Ionic Con- | True | Pellet | Relative |
|---|---|---|---|---|---|---|---|---|---|---|---|---|---|---|
| | Raw Materials | | | to Phosphorus | | | | | Size of | Size of | ductivity | Density | Density | Density |
| | Li₃PS₄ | LiBr | Lil | Li | S | Br + I | Br | I | Lil (nm) | LiBr (nm) | (mS/cm) | (g/cm³) | (g/cm³) | (%) |
| Example 1 | 100 | 12.5 | 75 | 3.88 | 4 | 0.88 | 0.13 | 0.75 | 7.21 | 7.28 | 1.59 | — | 2.18 | — |
| Example 2 | 100 | 12.5 | 100 | 4.13 | 4 | 1.13 | 0.13 | 1 | 10.58 | 15.68 | 1.88 | — | 2.22 | — |
| Example 3 | 100 | 12.5 | 125 | 4.38 | 4 | 1.38 | 0.13 | 1.25 | 14.39 | 16.55 | 1.69 | — | 2.37 | — |
| Example 4 | 100 | 12.5 | 150 | 4.63 | 4 | 1.63 | 0.13 | 1.5 | 15.62 | 19.22 | 1.44 | — | 2.45 | — |
| Example 5 | 100 | 25 | 75 | 4.00 | 4 | 1.00 | 0.25 | 0.75 | 6.01 | 7.43 | 1.43 | 2.41 | 2.20 | 91.48 |
| Example 6 | 100 | 25 | 100 | 4.25 | 4 | 1.25 | 0.25 | 1 | 10.11 | 13.96 | 1.51 | — | 2.34 | — |
| Example 7 | 100 | 25 | 125 | 4.50 | 4 | 1.50 | 0.25 | 1.25 | 13.01 | 17.53 | 1.60 | 2.56 | 2.39 | 93.67 |
| Example 8 | 100 | 25 | 150 | 4.75 | 4 | 1.75 | 0.25 | 1.5 | 14.10 | 18.02 | 1.47 | — | 2.39 | — |
| Example 9 | 100 | 37.5 | 75 | 4.13 | 4 | 1.13 | 0.38 | 0.75 | 7.94 | 10.98 | 1.51 | — | 2.25 | — |
| Example 10 | 100 | 37.5 | 100 | 4.38 | 4 | 1.38 | 0.38 | 1 | 8.69 | 17.39 | 1.65 | — | 2.23 | — |
| Example 11 | 100 | 37.5 | 125 | 4.63 | 4 | 1.63 | 0.38 | 1.25 | 12.42 | 22.38 | 1.34 | — | 2.55 | — |
| Example 12 | 100 | 37.5 | 150 | 4.88 | 4 | 1.88 | 0.38 | 1.5 | 13.67 | 17.07 | 1.36 | — | 2.48 | — |
| Example 13 | 100 | 37.5 | 175 | 5.13 | 4 | 2.13 | 0.38 | 1.75 | 15.25 | 17.17 | 1.25 | — | 2.57 | — |
| Example 14 | 100 | 50 | 50 | 4.00 | 4 | 1.00 | 0.50 | 0.5 | 7.66 | 3.52 | 1.67 | 2.31 | 2.23 | 96.59 |
| Example 15 | 100 | 50 | 100 | 4.50 | 4 | 1.50 | 0.50 | 1 | 32.51 | 38.34 | 1.62 | 2.51 | 2.32 | 92.26 |
| Example 16 | 100 | 100 | 0 | 4.00 | 4 | 1.00 | 1.00 | 0 | 8.02 | 12.95 | 1.19 | 2.23 | 2.10 | 93.87 |
| Example 17 | 100 | 100 | 50 | 4.50 | 4 | 1.50 | 1.00 | 0.5 | 8.33 | 12.39 | 1.48 | 2.47 | 2.23 | 90.12 |
| Example 18 | 100 | 100 | 100 | 5.00 | 4 | 2.00 | 1.00 | 1 | 30.14 | 30.13 | 1.67 | 2.55 | 2.38 | 93.46 |
| Example 19 | 100 | 150 | 0 | 4.50 | 4 | 1.50 | 1.50 | 0 | 17.78 | 14.52 | 1.25 | 2.38 | 2.17 | 91.26 |
| Comparative | 100 | 0 | 0 | 3.00 | 4 | 0.00 | 0.00 | 0 | absence | absence | 0.57 | 1.99 | 1.81 | 90.75 |
| Example 1 | | | | | | | | | | | | | | |
| Comparative | 100 | 0 | 25 | 3.25 | 4 | 0.25 | 0.00 | 0.25 | absence | absence | 0.93 | 2.25 | 1.93 | 85.85 |
| Example 2 | | | | | | | | | | | | | | |
| Comparative | 100 | 0 | 50 | 3.50 | 4 | 0.50 | 0.00 | 0.5 | absence | absence | 1.29 | — | 2.11 | — |
| Example 3 | | | | | | | | | | | | | | |
| Comparative | 100 | 0 | 75 | 3.75 | 4 | 0.75 | 0.00 | 0.75 | absence | absence | 1.66 | — | 2.15 | — |
| Example 4 | | | | | | | | | | | | | | |
| Comparative | 100 | 0 | 100 | 4.00 | 4 | 1.00 | 0.00 | 1 | 10.07 | absence | 1.88 | 2.47 | 2.18 | 88.28 |
| Example 5 | | | | | | | | | | | | | | |
| Comparative | 100 | 0 | 125 | 4,25 | 4 | 1.25 | 0.00 | 1.25 | 15.41 | absence | 1.79 | — | 2.26 | — |
| Example 6 | | | | | | | | | | | | | | |
| Comparative | 100 | 0 | 150 | 4.50 | 4 | 1.50 | 0.00 | 1.5 | 16.17 | absence | 1.67 | 2.62 | 2.28 | 86.91 |
| Example 7 | | | | | | | | | | | | | | |
| Comparative | 100 | 0 | 175 | 4.75 | 4 | 1.75 | 0.00 | 1.75 | 16.88 | absence | 1.58 | — | 2.54 | — |
| Example 8 | | | | | | | | | | | | | | |
| Comparative | 100 | 25 | 25 | 3.50 | 4 | 0.50 | 0.25 | 0.25 | absence | absence | 1.03 | 2.25 | 1.97 | 87.62 |
| Example 9 | | | | | | | | | | | | | | |
| Comparative | 100 | 50 | 0 | 3.50 | 4 | 0.50 | 0.50 | 0 | 7.74 | 8.22 | 1.78 | 2.10 | 1.86 | 88.68 |
| Example 10 | | | | | | | | | | | | | | |

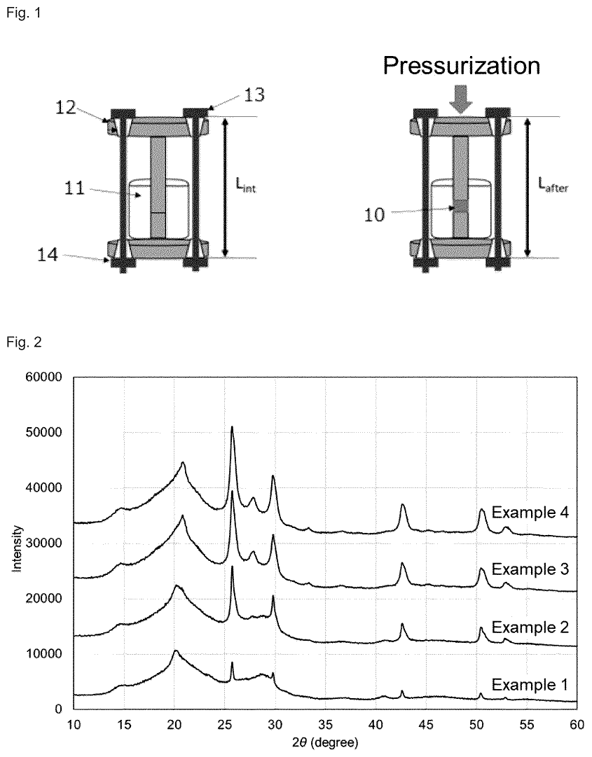

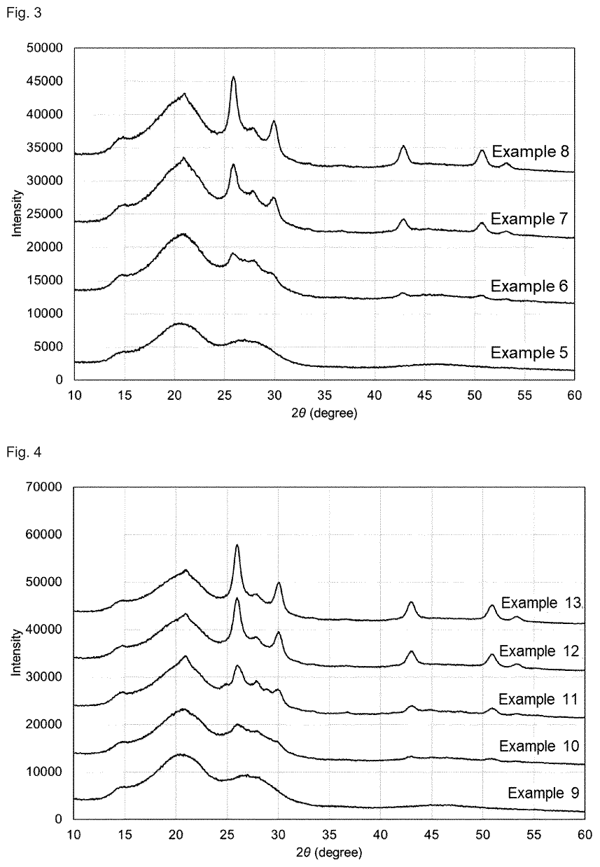

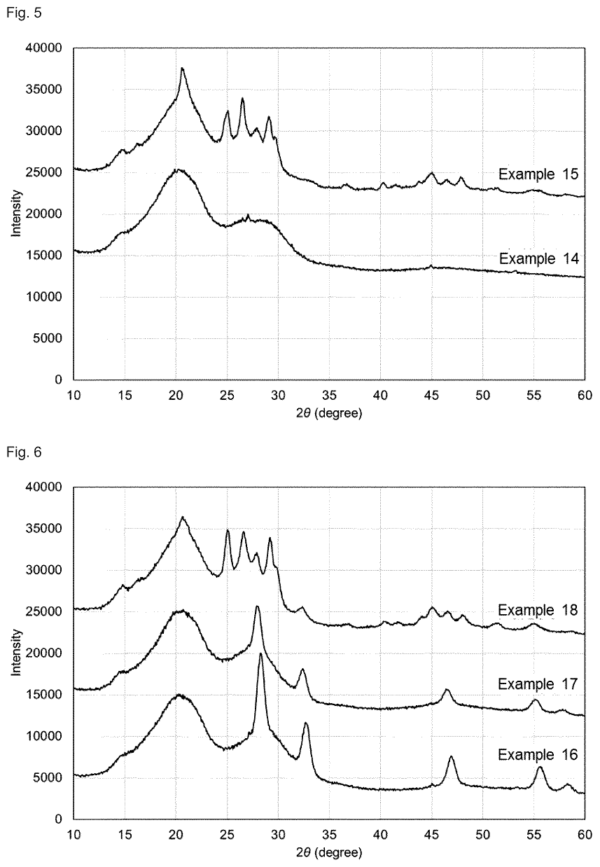

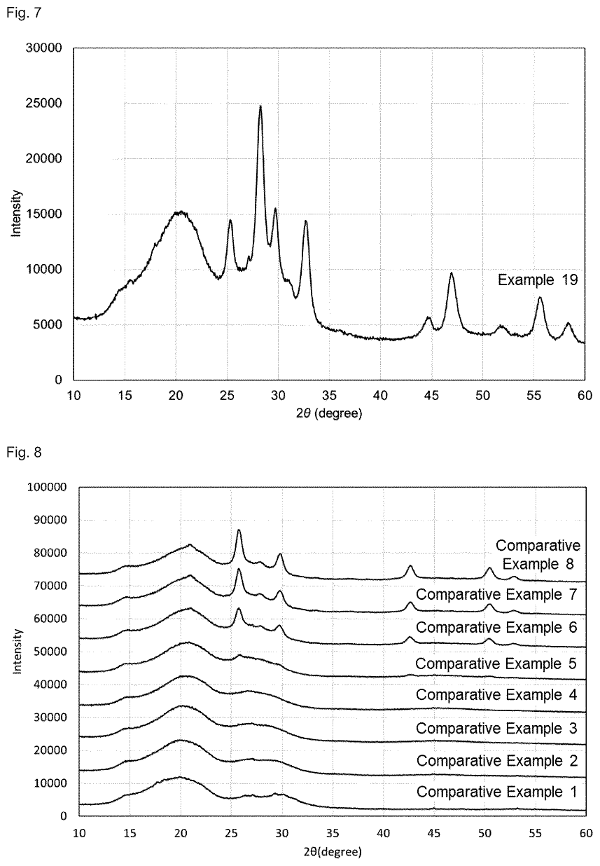

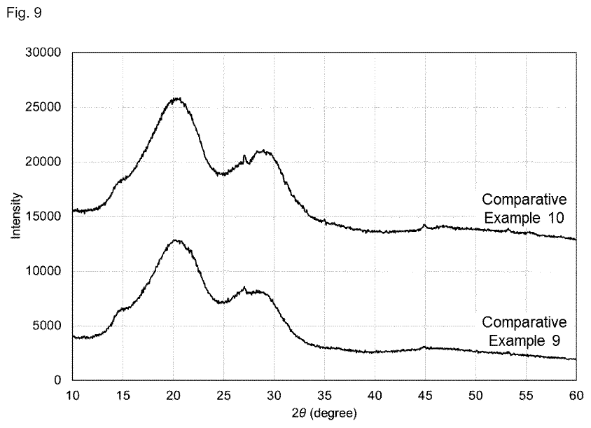

FIG. 2 shows X-ray diffraction patterns of the glass solid electrolytes prepared in Examples 1 to 4. FIG. 3 shows X-ray diffraction patterns of the glass solid electrolytes prepared in Examples 5 to 8. FIG. 4 shows X-ray diffraction patterns of the glass solid electrolytes prepared in Examples 9 to 13. FIG. 5 shows X-ray diffraction patterns of the glass solid electrolytes prepared in Examples 14 and 15. FIG. 6 shows X-ray diffraction patterns of the glass solid electrolytes prepared in Examples 16 to 18. FIG. 7 shows an X-ray diffraction pattern of the glass solid electrolyte prepared in Example 19. FIG. 8 shows X-ray diffraction patterns of the glass solid electrolytes prepared in Comparative Examples 1 to 8. FIG. 9 shows X-ray diffraction patterns of the glass solid electrolytes prepared in Comparative Examples 9 and 10.

From the XRD measurement results, it was confirmed that the glass solid electrolyte prepared in Examples 1 to 19 were amorphous, and that the raw material lithium halide existed in the state of being partially crystallized.

### INDUSTRIAL APPLICABILITY

The glass solid electrolyte of the present disclosure is suitable as a lithium-ion battery constituent material. In addition, the lithium-ion battery of the present disclosure is suitably used for information related devices such as a personal computer, a video camera, and a mobile phone, communication devices, battery used in vehicle such as electric vehicle, and the like.

Although only some exemplary embodiments and/or examples of this invention have been described in detail above, those skilled in the art will readily appreciate that many modifications are possible in the exemplary embodiments and/or examples without materially departing from the novel teachings and advantages of this invention. Accordingly, all such modifications are intended to be included within the scope of this invention.

The documents described in the specification and the specification of Japanese application(s) on the basis of which the present application claims Paris convention priority are incorporated herein by reference in its entirety.

1: A glass solid electrolyte comprising lithium, phosphorus, sulfur and halogen comprising at least bromine as constituent elements, wherein
a molar ratio (Li/P) of the lithium (Li) to the phosphorus (P) is 2.0 to 5.3,
a molar ratio (S/P) of the sulfur (S) to the phosphorus (P) is 2.0 to 4.5, and
a molar ratio (X/P) of the halogen (X) to the phosphorus (P) is 0.7 to 2.3, and
the glass solid electrolyte shows peaks derived from lithium bromide in powder X-ray diffraction using CuKα ray.

2: The glass solid electrolyte according to claim 1, wherein a crystallite size of lithium bromide calculated from a half-value width of a peak having a maximum intensity among the peaks derived from lithium bromide is 3 to 60 nm.

3: The glass solid electrolyte according to claim 1, wherein
the halogen further comprises iodine, and
the glass solid electrolyte shows peaks derived from lithium iodide in the powder x-ray diffraction using CuKα ray.

4: The glass solid electrolyte according to claim 3, wherein a crystallite size of lithium iodide calculated from a half-value width of a peak having the maximum intensity among the peaks derived from lithium iodide is 3 to 60 nm.

5: The glass solid electrolyte according to claim 1, wherein a relative density of a green compact pressurized at 400 MPa is 90% or more.

6: The glass solid electrolyte according to claim 1, having a true density of from 2.0 to 3.0 g/cm³.

7: The glass solid electrolyte according to claim 1, wherein the molar ratio (X/P) is greater than 0.75.

8: The glass solid electrolyte according to claim 1, wherein the molar ratio (X/P) is greater than 0.86.

9: The glass solid electrolyte according to claim 1, wherein
the halogen further comprises iodine,
a molar ratio (I/P) of the iodine (I) to the phosphorus (P) is 2.0 or less, and
a molar ratio (Br/P) of the bromine (Br) to the phosphorus (P) is 0.01 to 1.5.

10: The glass solid electrolyte according to claim 1, having an ionic conductivity of 1 mS/cm or greater.

11: A lithium-ion battery comprising the glass solid electrolyte according to claim 1.

12: A method for producing a glass solid electrolyte comprising:
combining two or more compounds containing lithium, phosphorus, sulfur, and a halogen (X) including at least bromine as constituent elements, or simple substances of the constituent elements, in a molar ratio (Li/P) of lithium (Li) to phosphorus (P) of 2.0 to 5.3, a molar ratio (S/P) of sulfur (S) to phosphorus (P) of 2.0 to 4.5, and a molar ratio (X/P) of halogen (X) to phosphorus (P) of 0.7 to 2.3, to form a mixture, and
vitrifying the mixture.
